(19) United States
(12) Patent Application Publication
(10) Pub. No.: US 2006/0155740 A1
(43) Pub. Date: Jul. 13, 2006

(54) Method, System and Program Product for Locating Remote Source Files

(75) Inventors: Xuan Zhang Chen, North York, Ontario (CA); Li Ding, North York, Ontario (CA); David K. McKnight, Newmarket, Ontario (CA); Kushal S. Munir, Toronto, Ontario (CA)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: INTERNATIONAL BUSINESS MACHINES CORPORATION, Armonk, NY (US)

(21) Appl. No.: 10/905,619

(22) Filed: Jan. 13, 2005

(51) Int. Cl. G06F 17/00

(52) U.S. Cl. 707/102

(57) ABSTRACT

Under the present invention, as a user/developer is developing a software program using an IDE, the user can designate a remote source container(s) (e.g., located on a server or the like that is remote from the local computer system) for one or more source files. When a remote source file is needed (e.g., during debug of the program), a cache on the local computer system will be examined first. If the remote source file is not present, or if the cache is not up to date, the remote system will be called. When the remote source file is received back on the local computer system, it will be stored in the cache and then made available to the user as needed. The system of the present invention is extensible to provide support for various platforms and to provide look up of source files inside additional archive types.

### FIELD OF THE INVENTION

In general, the present invention relates to source code development. Specifically, the present invention relates to a method, system and program product for locating remote source files during debugging and other code development phases/sessions.

### RELATED ART

Modern Integrated Development Environments (IDEs) provide integrated tooling for the development of software programs/applications. To facilitate the development of such programs, an IDE needs to provide support for editing and compiling source files as well as support for running and debugging the resulting applications. The debug capabilities of an IDE play a critical role in the productivity a user gains from its use. To provide useful integration with a debug engine, an IDE needs to provide the following: (1) the ability to set breakpoints from the UI, passing those breakpoints to the appropriate debug engine(s); and (2) the ability to present to the user the appropriate source files and lines of source when stepping through an application in a debugger.

Since, in an integrated development environment, the source files that a user needs to view while debugging are often the same files that the user edits when writing code to be compiled, it is often desirable that those same files are displayed by the debugger when stepping through code in a debug session. There are also cases where the user would prefer to see different source files while debugging—for example, if the application being debugged was compiled with a version of the code that differs from that which the user is editing. In addition to that, there are cases where the source that needs to be displayed in a debugger is not explicitly part of the program being developed, such as header and source files for libraries that are used by multiple applications. A debugger engine is able to obtain some information about which source files need to be displayed, although that information can be somewhat ambiguous.

Even when a debugger can determine exactly which source files are in need of display, the user may not necessarily want to be looking at the exact source when debugging. For example, if user needs to debug a IRE class on remote host/server, then it may make better sense that the remote source for IRE is displayed during a debug session rather than the local IRE source. So not only are the locations of source files to display during debug sessions ambiguous, but they are also a matter of preference. To solve this problem, many IDEs introduce a means for a user to specify where to pick up source files in a given debug session. For example, in the ECLIPSE IDE, the concept of a source locator is used to provide the user with an interface for specifying how to find the appropriate source for display. The source lookup framework supports source containers which actually look up source. The source container defines a common interface which can be implemented by individual tools. Users can choose the types of source containers and the order in which a source container is used for a source look up from the IDE.

From within the ECLIPSE workbench, a project, folder, archive or the Eclipse workspace itself, can be specified as the container of source to look within. Those source containers are useful for finding source contained in the local system with which user develops. However, much of the source that needs to be viewed is outside of the local system. In cases where the target applications reside on remote systems, common header files and library source are likely to only be found on those remote systems. ECLIPSE provides external source containers to deal with source files that exist outside of the Eclipse workspace, via an external folder container and external archive container. However, these still only deal with resources that exist on the local system. That is, there is nothing to support remote resources. One approach is to make a remote file system accessible via a mounted local drive, in which case it is possible to point to a remote folder via the ECLIPSE provided remote folder container. Unfortunately, the external source container in ECLIPSE, has the following problems:

(1) Performance is not optimized for remote source lookup. The ECLIPSE external source containers access the remote source via a mounted drive, which is treated as local. As such, the client issues search requests for each folder specified in the source container. Each search request has to traverse the network and will generate network traffic. This can raise substantial performance implications if a folder with many files is being searched, and becomes even worse for an external archive container because the client has to download the archive (files) and then search inside the archive.

(2) There is no inherent caching of external source files within the IDE workspace, so ECLIPSE external source containers always download source from remote host whenever it is asked to look up the source, even if it has been previously retrieved.

(3) The ECLIPSE external archive container only supports predefined archive types (e.g., .jar and .zip). If other types are needed (e.g., .tar), then new types of source containers need to be created if this is to be achieved in an extensible way.

In view of the foregoing, a need exists for method, system and program product for locating remote source files. Specifically, a need exists for a system that provides a remote source container that improves performance for looking up source files in remote folders and archives. A further need exists for the system that is extensible to provide support for various platforms. Still yet, a need exists for a system that can be extended to provide look up of source inside additional archive types.

### SUMMARY OF THE INVENTION

In general, the present invention provides a method, system and program product for locating remote source files. Specifically, the present invention can be embodied as a plug-in or the like to an IDE that allows containers to be designated for looking up source files in remote folders, archives, etc. Under the present invention, as a user/developer is developing a software program using an IDE, the user can designate a remote source container(s) (e.g., located on a server or the like that is remote from the local computer system) for one or more source files. When a remote source file is needed (e.g., during debug of the program), a cache on the local computer system will be examined first. If the remote source file is not present, or if the cache is not up to date, the remote system will be called to search for the requested remote source file. When the remote source file is received back on the local computer system, it will be stored in the cache and then made available to the user as needed. The system of the present invention is extensible to provide support for various platforms and to provide look up of source files inside additional archive types.

A first aspect of the present invention provides a method for locating remote source files, comprising: a system for receiving a selection of a remote source container on a local computer system; receiving a request for a remote source file during a session with an Integrated Development Environment (IDE) on the local computer system; examining a cache on the local computer system; retrieving the remote source file from the cache if the cache contains the remote source file and content in the cache is up to date; calling a remote computer system to search for the remote source file based on the remote source container if the cache does not contain the remote source file or if the cache is not up to date; and receiving the remote source file on the local computer system, and storing the remote source file in the cache.

A second aspect of the present invention provides an Integrated Development Environment (IDE) plug-in for locating remote source files, comprising: means for receiving a selection of a remote source container on a local computer system; means for receiving a request for a remote source file during a session with an Integrated Development Environment (IDE) on the local computer system; means for examining a cache on the local computer system; means for retrieving the remote source file from the cache if the cache contains the remote source file and content in the cache is up to date; means for calling a remote computer system to search for the remote source file based on the remote source container if the cache does not contain the remote source file or if the cache is not up to date; and means for receiving the remote source file on the local computer system, and storing the remote source file in the cache.

A third aspect of the present invention provides a program product stored on a recordable medium for locating remote source files, which when executed, comprises: program code for receiving a selection of a remote source container on a local computer system; program code for receiving a request for a remote source file during a session with an Integrated Development Environment (IDE) on the local computer system; program code for examining a cache on the local computer system; program code for retrieving the remote source file from the cache if the cache contains the remote source file and content in the cache is up to date; program code for calling a remote computer system to search for the remote source file based on the remote source container if the cache does not contain the remote source file or if the cache is not up to date; and program code for receiving the remote source file on the local computer system, and storing the remote source file in the cache.

A fourth aspect of the present invention provides a system for locating remote source files, comprising: a system for receiving a selection of a remote source container on a local computer system; a system for receiving a request for a remote source file during a session with an Integrated Development Environment (IDE) on the local computer system; a system for examining a cache on the local computer system; a system for retrieving the remote source file from the cache if the cache contains the remote source file and content in the cache is up to date; a system for calling a remote computer system to search for the remote source file based on the remote source container if the cache does not contain the remote source file or if the cache is not up to date; and a system for receiving the remote source file on the local computer system, and storing the remote source file in the cache.

A fifth aspect of the present invention provides computer software embodied in a propagated signal for locating remote source files, the computer software comprising instructions to cause a computer system to perform the following functions: receive a selection of a remote source container on a local computer system; receive a request for a remote source file during a session with an Integrated Development Environment (IDE) on the local computer system; examine a cache on the local computer system; retrieve the remote source file from the cache if the cache contains the remote source file and content in the cache is up to date; call a remote computer system to search for the remote source file based on the remote source container if the cache does not contain the remote source file or if the cache is not up to date; and receive the remote source file on the local computer system, and store the remote source file in the cache.

A sixth aspect of the present invention provides a method for deploying an application for locating remote source files, comprising: providing a computer infrastructure being operable to: receive a selection of a remote source container on a local computer system; receive a request for a remote source file during a session with an Integrated Development Environment (IDE) on the local computer system; examine a cache on the local computer system; retrieve the remote source file from the cache if the cache contains the remote source file and content in the cache is up to date; call a remote computer system to search for the remote source file based on the remote source container if the cache does not contain the remote source file or if the cache is not up to date; and receive the remote source file on the local computer system, and store the remote source file in the cache.

Therefore, the present invention provides a method, system and program product for locating remote source files.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a system for locating remote source files according to the present invention.

FIG. 2 depicts a first illustrative interface for selecting a remote source container according to the present invention.

FIG. 3 depicts a second illustrative interface for selecting a remote source container according to the present invention.

FIG. 4 depicts a third illustrative interface for selecting a remote source container according to the present invention.

FIG. 5 depicts a method flow diagram according to the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE DRAWINGS

As indicated above, the present invention provides a method, system and program product for locating remote source files. Specifically, the present invention can be embodied as a plug-in or the like to an IDE that allows containers to be designated for looking up source files in remote folders, archives, etc. Under the present invention, as a user/developer is developing a software program using an IDE, the user can designate a remote source container(s) (e.g., located on a server or the like that is remote from the local computer system) for one or more source files. When a remote source file is needed (e.g., during debug of the program), a cache on the local computer system will be examined first. If the remote source file is not present, or if the cache is not up to date, the remote system will be called to search for the requested remote source file. When the remote source file is received back on the local computer system, it will be stored in the cache and then made available to the user as needed. The system of the present invention is extensible to support an optimized search mechanism for various platforms and to provide look up of source files inside additional archive and file types.

It should be understood in advance that as used herein, the term “source file” pertains to any type of file containing computer source code. Further, the term “remote source file” is intended to mean a source file that is located remotely from a computer system that being used to develop a software program associated with the computer source code contained in the source file (e.g., a source file located on a server or host).

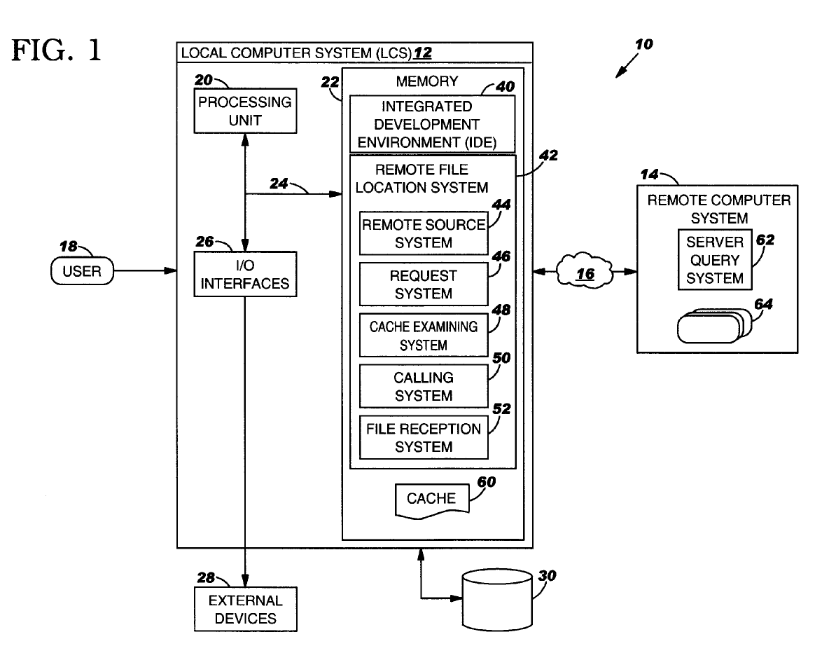

Referring now to FIG. 1, an illustrative system 10 for locating remote source files according to the present invention is shown. As depicted, system 10 includes a client or local computer system 12 (hereinafter LCS 12) that communicates with a server/host or remote computer system 14 (hereinafter RCS 14) over a network 16, which can be any type of network such as the Internet, a local area network (LAN), a wide area network (WAN), a virtual private network (VPN), etc. Communication throughout network 16 could occur via a direct hardwired connection (e.g., serial port), or via an addressable connection that may utilize any combination of wireline and/or wireless transmission methods. Conventional network connectivity, such as Token Ring, Ethernet, WiFi or other conventional communications standards could be used. Still yet, connectivity could be provided by conventional IP-based protocol. In this instance, an Internet service provider could be used to establish interconnectivity.

As shown, LCS 12 includes processing unit 20, memory 22, bus 24, input/output (I/O) interfaces 26, external devices/resources 28 and storage unit 30. Processing unit 20 may comprise a single processing unit, or be distributed across one or more processing units in one or more locations, e.g., on a client and server. Memory 22 may comprise any known type of data storage and/or transmission media, including magnetic media, optical media, random access memory (RAM), read-only memory (ROM), a data cache, a data object, etc. Moreover, similar to processing unit 20, memory 22 may reside at a single physical location, comprising one or more types of data storage, or be distributed across a plurality of physical systems in various forms.

I/O interfaces 26 may comprise any system for exchanging information to/from an external source. External devices/resources 28 may comprise any known type of external device, including speakers, a CRT, LED screen, hand-held device, keyboard, mouse, voice recognition system, speech output system, printer, monitor/display, facsimile, pager, etc. Bus 24 provides a communication link between each of the components in LCS 12 and likewise may comprise any known type of transmission link, including electrical, optical, wireless, etc.

Storage unit 30 can be any system (e.g., a database, etc.) capable of providing storage for information under the present invention. As such, storage unit 30 could include one or more storage devices, such as a magnetic disk drive or an optical disk drive. In another embodiment, storage unit 30 includes data distributed across, for example, a local area network (LAN), wide area network (WAN) or a storage area network (SAN) (not shown). Although not shown, additional components, such as cache memory, communication systems, system software, etc., may be incorporated into LCS 12. Moreover, it should be understood that RCS 14 will include computerized components similar to LCS 12. Such components have not been depicted for illustrative purposes only.

Shown in memory 20 of LCS 12 as a program product is Integrated Development Environment (IDE 40) and remote file location system 42. As will be further described below, remote file location system 42 provides the capability to obtain source (code) files 64 located remotely from LCS 12 (e.g., on RCS 14). As mentioned above, such files are typically useful as a program is being developed (e.g., during a debug session). In a typical embodiment, remote source location system 42 is embodied/realized as a plug-in to IDE 40. However, it should be appreciated that IDE could be realized in any number of ways. Further, IDE 40 can be any type of IDE now known or later developed (e.g., ECLIPSE). As depicted, remote source location system 42 includes remote source system 44, request system 46, cache examining system 48, calling system 50 and file reception system 52. In general, remote source location system 42 is extensible to provide support for various platforms, and to provide look up of source files inside additional archive types.

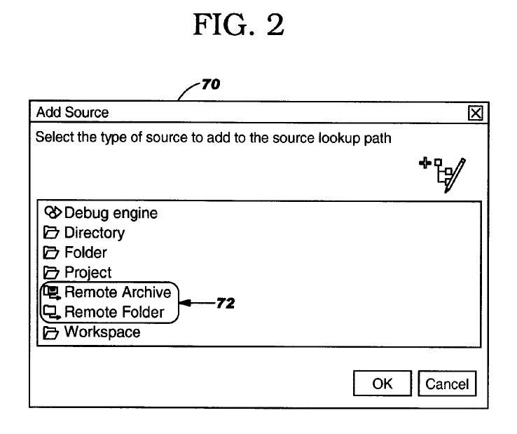

Remote source system 44 allows user/developer 18 to dynamically define/designate the types of folder and archives supported by the present invention. For example, using remote source system 44, user 18 could designate that .zip, .jar., .tar, .cpp, etc. archive types will be supported. Remote source system 44 also allows remote source location system 42 to be optimized for different platforms. Still further, remote source system 44 also allows user 18 to select/designate remote source containers as locations for obtaining remote source files. In general, a remote source container means any “container” (e.g., folders, archives, etc.) for files and the like that is remote from the point of view of LCS 12. To this extent, remote source system 44 can provide one or more interface pages that allow user 18 to make such selections. For example, assume that user 18 was currently attempting to debug a software program under development. Further assume that user 18 wishes to obtain one or more remote source files 64 for the debug session. In this case, remote source system 44 can initially provide an interface page 70 such as that shown in FIG. 2. As depicted in FIG. 2, interface page 70 includes selections for one or more remote source containers 72, which is shown as including both “remote folders” and “remote archives.”

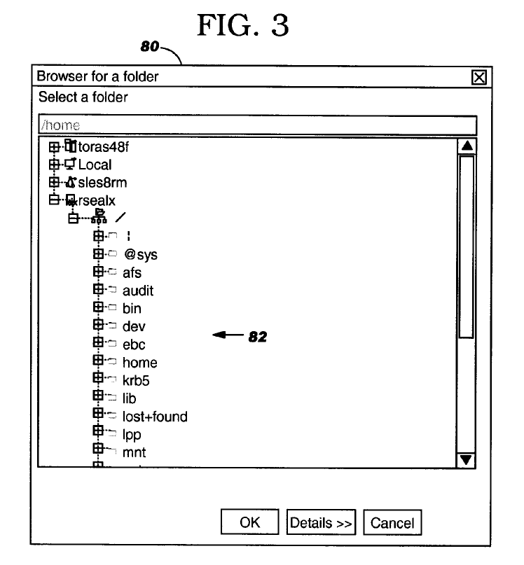

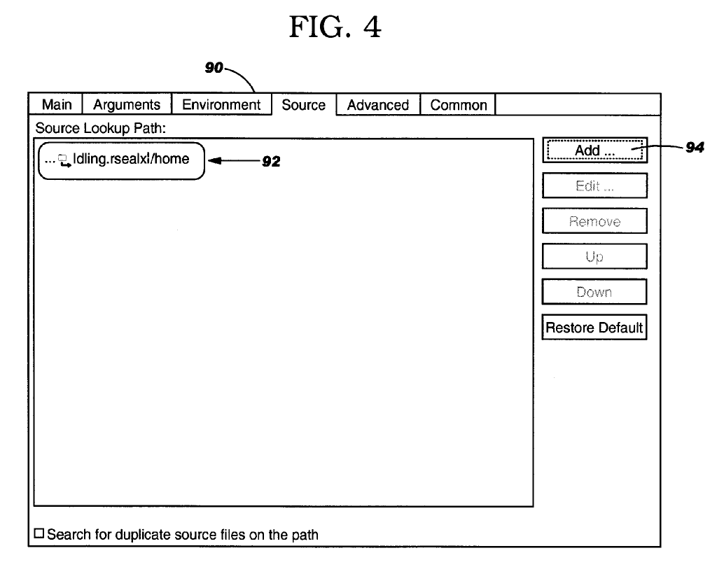

Under the present invention, a remote source container specifies a search path remote from LCS 12 (e.g., on RCS 14) for locating remote source files. If user 18 (FIG. 1) selects one or more of remote source containers 72, the selection will be received by remote source system 44 (FIG. 1), which will then provide interface page 80 of FIG. 3. As shown, interface page 80 allows user 18 to further “drill down” to select a particular directory and sub-directory as a remote source container. If user selects the “home” directory as highlighted in FIG. 3, the selection will be received by remote source system 44 (FIG. 1), which will then provide interface page 90 of FIG. 4 that summarizes user 18's selection. As depicted, user 18 has selected a remote source container comprised of the search path 92 “lding.rseaix:/home.” For the purposes of this disclosure, assume that search path 92 is located on RCS 14 (FIG. 1), or in some other location that is remote from LCS 12 and is accessible to RCS 14. Regardless, upon selecting the add button 94, search path 92 will be added to a list of locations from which source files can be retrieved.

Referring back to FIG. 1, now assume that during the debug session, user 18 desires a particular remote source file entitled “ABC.CPP.” In such a case, user 18 will issue a request for the remote source file (e.g., by file name using currently technology existing within IDE 40). The request will be received by request system 46. Upon receipt, cache examining system 48 will first determine whether LCS 12 has a cache 60 (e.g., check to see if there is content in cache 60). If so, cache examining system 48 will then determine whether the content in cache 60 is up to date and if it contains the requested remote source file. If: (1) LCS 12 has a cache 60 that is up to date and includes the requested remote source file, it will be retrieved from cache 60 and made available to user 18. However, if cache 60 is non-existent or empty, or is not up to date, the present invention allows the designated remote source containers to be searched.

For example, assume that the requested remote source file was not contained in cache 60. In this case, calling system 50 will call RCS 14 to search for the requested remote source file. In calling RCS 14 under the present invention, calling system 50 will generate and transmit a request to RCS 14 that specifies the remote source container (e.g., “lding.rseaix:/home”) and the requested remote source file (e.g., ABC.CPP). The request will be received by server query system 62, which will search/query the designated remote source container for the requested remote source file. In the event multiple remote source files are found, remote source container can specify a method to sort the same. In any event, as can be seen, the processing duties for actually performing the search/query are now placed on RCS 14, as opposed to LCS 12. In previous approaches where remote source location was not provided, all search/query duties were placed on LCS 12, which greatly reduced efficiency.

Assuming that the requested remote source file is located in the designated remote source container, the requested remote source file will be transmitted back to LCS 12 where it will be received by file reception system 52. Upon receipt, file reception system 52 will make the remote source file available to user 18. File reception system 52 will also store the remote source file in cache 60 in case it is needed again by user 18. If the requested source file or the remote source container could not be found, RCS 14 can communicate an error message or the like back to LCS 12.

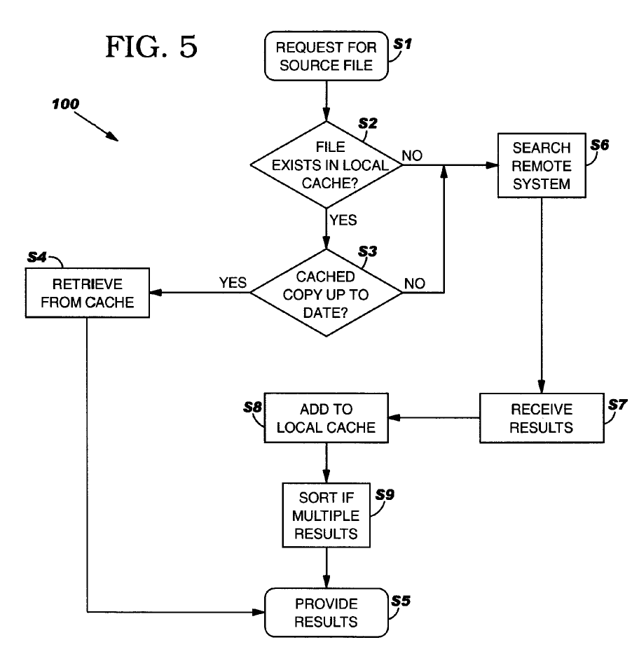

Referring now to FIG. 5, a method flow diagram 100 of the present invention is shown. In step S1, a remote source file is requested. In step S2, it is determined whether the requested remote source file exists in local cache. If so, it is determined in step S3 whether the cache content is up to date. If so, the requested remote source file is retrieved from cache in step S4, and results are returned to the user in step S5. If, however, the local cache did not contain the requested remote source file in step S2, or was not up to date in step S3, the remote system will be searched step S6 and the results will be received in step S7. Upon receipt, the results will be added the local cache in step S8. If multiple remote source files were received in step S7, they will be sorted in step S9 before being provided to the user in step S5.

It should be understood that although not discussed above, various extensions to the present invention could be made. For example, remote source location system 42 could provide user 18 with the capability to associate specific remote source files with designated remote source containers. For example, user 18 could be provided with interface page(s) that allow him/her to specifically associate source file “ABC.CPP” with the directory “lding.rseaix:/home.” When such an association is made, server query system 62 (FIG. 1) need only search this one directory when source file “ABC.CPP” is requested, thus reducing processing time and resources.

It should also be appreciated that the present invention could be offered as a business method on a subscription or fee basis. For example, remote source location system 42 could be created, supported, maintained and/or deployed by a service provider that offers the functions described herein for customers. That is, a service provider could offer to location remote source files for customers.

Still yet, it should be understood that the present invention could be realized in hardware, software, a propagated signal, or any combination thereof. Any kind of computer/server system(s)—or other apparatus adapted for carrying out the methods described herein—is suited. A typical combination of hardware and software could be a general purpose computer system with a computer program that, when loaded and executed, carries out the respective methods described herein. Alternatively, a specific use computer, containing specialized hardware for carrying out one or more of the functional tasks of the invention, could be utilized. The present invention can also be embedded in a computer program product or a propagated signal, which comprises all the respective features enabling the implementation of the methods described herein, and which—when loaded in a computer system—is able to carry out these methods. Computer program, propagated signal, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the preferred embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims. For example, a particular configuration of sub-systems is depicted within remote source location system 42 for illustrative purposes only. To this extent, the functions thereof could be carried out by a different configuration.

What is claimed is:

1. A method for locating remote source files, comprising:
receiving a selection of a remote source container on a local computer system;
receiving a request for a remote source file during a session with an Integrated Development Environment (IDE) on the local computer system;
examining a cache on the local computer system;
retrieving the remote source file from the cache if the cache contains the remote source file and content in the cache is up to date;
calling a remote computer system to search for the source file based on the remote source container if the cache does not contain the source file or if the cache is not up to date; and
receiving the source file on the local computer system, and storing the source file in the cache.

2. The method of claim 1, wherein the remote source container specifies a search path on the remote computer system.

3. The method of claim 1, wherein the session is a debug session for a software program being developed using the IDE.

4. The method of claim 1, wherein the examining step comprises:
determining whether the local computer system has a cache;
determining whether content in the cache is up to date; and
checking the cache for the remote source file.

5. The method of claim 1, wherein the remote source container specifies a method to sort source files if multiple source files are found.

6. The method of claim 1, further comprising defining folders and archive types for the remote source container.

7. The method of claim 1, further comprising the step of providing at least one interface within the IDE for selecting the remote source container.

8. The method of claim 7, wherein the selection is made via the at least one interface.

9. An Integrated Development Environment (IDE) plug-in for locating remote source files, comprising:
means for receiving a selection of a remote source container on a local computer system;
means for receiving a request for a remote source file during a session with an Integrated Development Environment (IDE) on the local computer system;
means for examining a cache on the local computer system;
means for retrieving the remote source file from the cache if the cache contains the remote source file and content in the cache is up to date;
means for calling a remote computer system to search for the remote source file based on the remote source container if the cache does not contain the remote source file or if the cache is not up to date; and
means for receiving the remote source file on the local computer system, and storing the remote source file in the cache.

10. The IDE of claim 9, wherein the remote source container specifies a search path on the remote computer system.

11. The IDE of claim 9, wherein the session is a debug session for a software program being developed using the IDE.

12. The IDE of claim 9, wherein the means for examining the cache includes:
means for determining whether the local computer system has a cache;
means for checking whether content in the cache is up to date; and
means for checking the cache for the remote source file.

13. The IDE of claim 9, wherein the remote source container specifies a method to sort source files if multiple source files are found.

14. The IDE of claim 9, further comprising means for defining folders and archive types for the remote source container.

15. The IDE of claim 9, further comprising means for providing at least one interface within the IDE for selecting the remote source container.

16. The IDE of claim 9, wherein the selection is made via the at least one interface.

17. The IDE plug-in of claim 16, wherein the session is a debug session for a software program being developed using the IDE.

18. A program product stored on a recordable medium for locating remote source files, which when executed comprises:
program code for receiving a selection of a remote source container on a local computer system;
program code for receiving a request for a remote source file during a session with an Integrated Development Environment (IDE) on the local computer system;
program code for examining a cache on the local computer system;
program code for retrieving the remote source file from the cache if the cache contains the remote source file and content in the cache is up to date;
program code for calling a remote computer system to search for the remote source file based on the remote source container if the cache does not contain the remote source file or if the cache is not up to date; and
program code for receiving the remote source file on the local computer system, and storing the remote source file in the cache.

19. The program product of claim 18, wherein the remote source container specifies a search path on the remote computer system.

20. The program product of claim 18, wherein the session is a debug session for a software program being developed using the IDE.

21. The program product of claim 18, wherein the program code for examining the cache includes:
program code for determining whether the local computer system has a cache;
program code for checking whether content in the cache is up to date; and
program code for checking the cache for the remote source file.

22. The program product of claim 18, wherein the remote source container specifies a method to sort source files if multiple source files are found.

23. The program product of claim 18, wherein the remote source container contains search folders and archive types that can dynamically defined.

24. The program product of claim 18, further comprising program code for providing at least one interface within the IDE for selecting the remote source container.

25. The program product of claim 24, wherein the selection is made via the at least one interface.
